(19) United States
(12) Patent Application Publication
(10) Pub. No.: US 2025/0250693 A1
(43) Pub. Date: Aug. 7, 2025

(54) DIRECT INTEGRATED COMPOSITE MEMBRANES FOR ELECTROLYZERS AND METHODS FOR MAKING THE SAME

(71) Applicant: GM Global Technology Operations LLC, Detroit, MI (US)

(72) Inventors: Craig S. Gittleman, West Bloomfield, MI (US); Swaminatha P. Kumaraguru, Rochester Hills, MI (US); Ruichun Jiang, Troy, MI (US)

(73) Assignee: GM Global Technology Operations LLC, Detroit, MI (US)

(21) Appl. No.: 18/432,380

(22) Filed: Feb. 5, 2024

(51) Int. Cl. C25B 9/23; C25B 11/032; C25B 11/042; C25B 11/081; C25B 13/08

(52) U.S. Cl. CPC C25B 9/23; C25B 11/032; C25B 11/042; C25B 11/081; C25B 13/08

(57) ABSTRACT

A gas diffusion electrode membrane for one of a proton exchange membrane electrolyzer or an alkaline electrolyzer includes a substrate formed of one or more gas diffusion layers including a macro porous substrate and microporous layers, the electrode layer including a platinum-based metal alloy. The gas diffusion electrode membrane further including an electrode layer including a platinum-based metal alloy and a membrane integrated with the electrode layer and simultaneously applied to the substrate with the electrode layer, applying the membrane and the electrode layer directly to the substrate being performed at a single location as part of a single process.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to direct integrated composite membranes for electrolyzers and methods for making the same. Specifically, electrolyzers are devices that perform electrolysis, which is the process of using electricity to split water into oxygen and hydrogen, which may be used as fuel in vehicles, such as automobiles. Electrolyzers consist of an anode and a cathode separated by an electrolyte, which may be an anion exchange ionomer, specifically a poly quaternary ammonium hydroxide, or a proton exchange membrane (PEM) electrolyzer, where the electrolyte is an acidic proton conductor. The electrolyte membrane is impermeable to gases such as hydrogen and oxygen.

Electrolyzers may include a membrane electrode assembly (MEA), which helps produce the electrochemical reactions needed to generate hydrogen. On the anode side of the MEA, water reacts on an electrocatalyst to form oxygen, electrons, and protons. The protons migrate through the membrane to the cathode where they receive the electrons that were separated from the water, combine, and react on a second electrocatalyst to form the hydrogen product. The electrolyte membrane allows protons to pass through while keeping the gases separate. An external power supply is used to apply an electric potential to the electrolyzer to maintain the current used to generate hydrogen.

In a traditional electrolyzer, the membrane is prepared independent to other electrolyzer components as a stand-alone component. The obtained membrane is subsequently physically attached to electrode layers to make an MEA. There is room for improvement in this field to reduce cost, improve interface connections, and increase flexibility on membrane materials design and selection.

### SUMMARY

One aspect of the disclosure provides a gas diffusion electrode membrane assembly for one of a proton exchange membrane electrolyzer or an alkaline exchange membrane electrolyzer to generate hydrogen for use as fuel in a vehicle, the electrode membrane assembly comprising a substrate including an electrode layer applied directly to the substrate, the substrate being formed of one or more gas diffusion layers including a macro porous substrate and microporous layers, the electrode layer including an electrocatalyst. The gas diffusion electrode membrane assembly further including a membrane applied directly to the electrode layer that is on the substrate, the membrane being applied directly to the electrode layer that is on the substrate using at least one operation including wet coating, spraying, or sputtering. Applying the membrane directly to the electrode layer that is on the substrate is performed at a single location as part of a single process.

Implementations of the disclosure may include one or more of the following optional features. In some implementations, the gas diffusion electrode membrane assembly further includes a second substrate including a second electrode layer and a second membrane that is applied to the second electrode layer. The gas diffusion electrode membrane assembly further includes a reinforcement layer applied to one of the membrane and the second membrane, wherein the reinforcement layer is laminated between the membrane and the second membrane.

The gas diffusion electrode membrane assembly further includes an electrolyte that is an anion exchange ionomer.

The membrane includes a perfluorosulfonic acid ionomer.

The electrocatalyst includes a precious metal selected from the group consisting of platinum, iridium, ruthenium, and ruthenium-iridium.

The membrane includes chemical mitigation additives including one or more of Cerium, Manganese, Cobalt, salts, or oxides.

Another aspect of the disclosure provides a gas diffusion electrode membrane assembly for one of a proton exchange membrane electrolyzer or an alkaline electrolyzer, the electrode membrane assembly comprising a substrate formed of one or more gas diffusion layers including a macro porous substrate and microporous layers, the electrode layer including a platinum-based metal alloy. The electrode membrane assembly further including an electrode layer including a platinum-based metal alloy and a membrane integrated with the electrode layer and simultaneously applied to the substrate with the electrode layer, wherein applying the membrane and the electrode layer directly to the substrate is performed at a single location as part of a single process.

Implementations of the disclosure may include one or more of the following optional features. In some implementations, the gas diffusion electrode membrane assembly further includes a second substrate including a second electrode layer and a second membrane that is applied to the second electrode layer. The gas diffusion electrode membrane assembly further includes a reinforcement layer applied to one of the membrane and the second membrane, wherein the reinforcement layer is laminated between the membrane and the second membrane.

The gas diffusion electrode membrane assembly further includes an electrolyte that is an anion exchange ionomer.

The membrane includes a perfluorosulfonic acid ionomer.

The electrocatalyst includes a precious metal selected from the group consisting of platinum, iridium, ruthenium, and ruthenium-iridium.

The membrane includes chemical mitigation additives including one or more of Cerium, Manganese, Cobalt, salts, or oxides.

Another aspect of the disclosure provides a method for making a gas diffusion electrode membrane comprising providing a substrate, performing one of applying an electrode layer directly to the substrate and applying a membrane directly to the electrode layer, or integrating an electrode layer with a membrane and simultaneously applying the electrode layer and the membrane to the substrate.

Implementations of the disclosure may include one or more of the following optional features. In some implementations, the membrane may be applied directly to the electrode layer or the substrate as a single layer or as multiple layers.

The method further includes the step of providing an electrolyte that is an anion exchange ionomer.

The membrane includes a perfluorosulfonic acid ionomer.

The electrocatalyst includes a precious metal selected from the group consisting of platinum, iridium, ruthenium, and ruthenium-iridium.

The membrane includes chemical mitigation additives including one or more of Cerium, Manganese, Cobalt, salts, or oxides.

The details of one or more implementations of the disclosure are set forth in the accompanying drawings and description below. Other aspects, features, and advantages will be apparent from the description, drawings, and claims.

### BRIEF DESCRIPTION OF THE DRAWINGS

The drawings described herein are for illustrative purposes only of selected configurations and are not intended to limit the scope of the present disclosure.

FIG. 1 is a side view schematic of a membrane electrode assembly (MEA) including a gas diffusion electrode membrane assembly (GDEMA) in accordance with principles of the present disclosure;

FIG. 2 is a side exploded view of the MEA of FIG. 1;

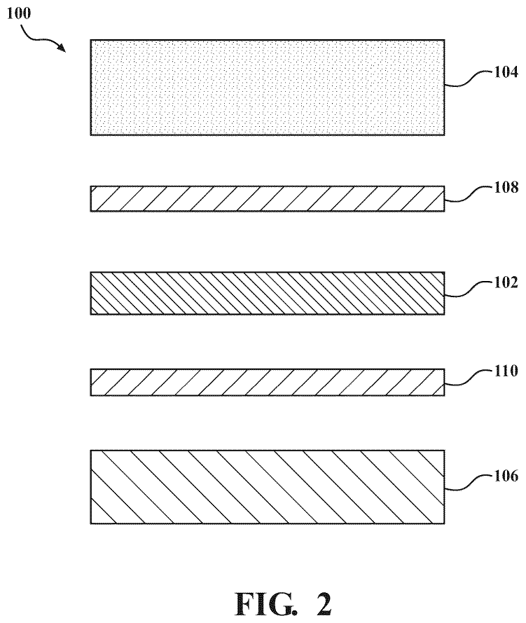

FIG. 3 is a schematic illustrating a method of manufacturing an exemplary GDEMA of FIG. 1;

FIG. 4 is a schematic illustrating a method of manufacturing an exemplary GDEMA of FIG. 1;

FIG. 5 is a schematic illustrating a method of manufacturing an exemplary GDEMA of FIG. 1; and

FIG. 6 is a schematic illustrating a method of manufacturing an exemplary GDEMA, including a reinforcement layer, of FIG. 1.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

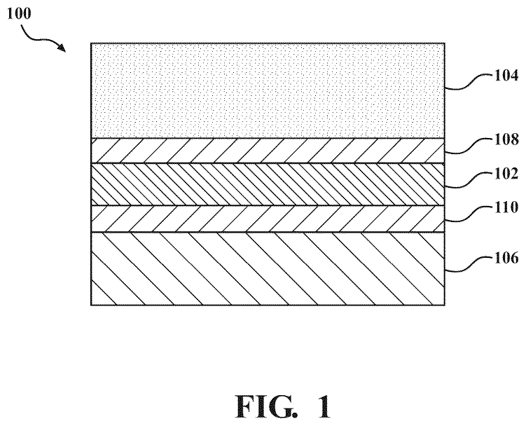

Referring to FIG. 1, a membrane electrode assembly (MEA) 100 is generally shown. The MEA 100 may be incorporated into a proton exchange membrane (PEM) electrolyzer or an alkaline exchange membrane (AEM) electrolyzer. Any of the aforementioned electrolyzers may be configured to split water into oxygen and hydrogen, which may be used as fuel in vehicles, such as automobiles, or fuel in any other suitable application. The MEA 100 includes a membrane 102, a corrosion resistant porous substrate 104, and a porous substrate 106.

In a PEM electrolyzer, the membrane 102 may use perfluorosulfonic acid (PFSA) or non-PFSA ionomer materials. The membrane 102 can have reinforcement materials 114 such as expanded polytetrafluoroethylene (ePTFE) or any other suitable materials for mechanical support. Any reinforcement materials of the membrane 102 may form a reinforcement layer, which may have a reinforcement layer thickness between 0-100% of the total thickness of the membrane 102.

The membrane 102 may have gas recombination catalysts (GRC), such as Platinum, Platinum on Carbon, Platinum on Silica, or other additives. Any GRC of the membrane 102 may form a gas recombination layer (GRL) having a GRL thickness between 0-100% of the total thickness of the membrane 102. The membrane 102 may include chemical mitigation additives, such as Cerium, Manganese, Cobalt, etc., in different format of chemical compounds such as salts, oxides, or others.

The corrosion resistant substrate 104 may be a porous transport layer (PTL) or any other suitable substrate. The corrosion resistant substrate 104 may be formed from titanium-based components, such as sintered titanium particle substrates, titanium fiber paper, expanded titanium mesh, or any other suitable material. The corrosion resistant substrate 104 is designed to be porous and conductive, both in-plane and through plane. The corrosion resistant substrate 104 is configured to receive and be coated with an anode catalyst ink to form an anode catalyst layer 108. After application of the anode catalyst ink to the corrosion resistant substrate 104, the anode catalyst layer 108 and the corrosion resistant substrate 104 may be dried using heat treatment, plasma treatment, or any other suitable process. The anode catalyst layer 108 primarily includes both catalyst and binder. Ionomer, in addition to proton conducting function, acts as a binder in most cases. In some implementations, the anode catalyst layer 108 may include ionomer strands protruding into the corrosion resistant substrate 104. The depth of the ionomer strands of the anode catalyst layer 108 protruding into the corrosion resistant substrate 104 is between approximately 1-80% of the total thickness of the corrosion resistant substrate 104. In other implementations, the anode catalyst layer 108 may be adjacent to, but not protrude into, the corrosion resistant substrate 104. The anode catalyst layer 108 may be applied to the corrosion resistant substrate 104 via slot die, spray coating methods, sputtering, or any other suitable method.

The porous substrate 106 may be a gas diffusion layer (GDL) or any other suitable substrate. The porous substrate 106 may be formed from carbon-based components, such as carbon cloth, carbon paper, and/or any other suitable material. The porous substrate 106 is configured to receive and be coated with a cathode catalyst ink to form a cathode catalyst layer 110. After application of the cathode catalyst ink to the porous substrate 106, the cathode catalyst layer 110 and the porous substrate 106 may be dried using heat treatment, plasma treatment, or any other suitable process. In some implementations, the cathode catalyst layer 110 includes ionomer strands protruding into the porous substrate 106. The depth of the ionomer strands of the cathode catalyst layer 110 protruding into the porous substrate 106 is between approximately 1-80% of the total thickness of the porous substrate 106. In other implementations, the cathode catalyst layer 110 may be adjacent to, but not protrude into, the porous substrate 106. The cathode catalyst layer 110 may be applied to the porous substrate 106 via slot die, spray coating methods, sputtering, or any other suitable method.

The catalyst layers 108, 110 may include precious or non-precious metals or compounds including, but not limited to, metal or metal alloys such as platinum, iridium, ruthenium, and ruthenium-iridium. As set forth in greater detail below, the catalyst layers 108, 110 may be applied to the substrates 104, 106 before the membrane 102, or the catalyst layers 108, 110 may be applied to the substrates 104, 106 simultaneously with the membrane 102.

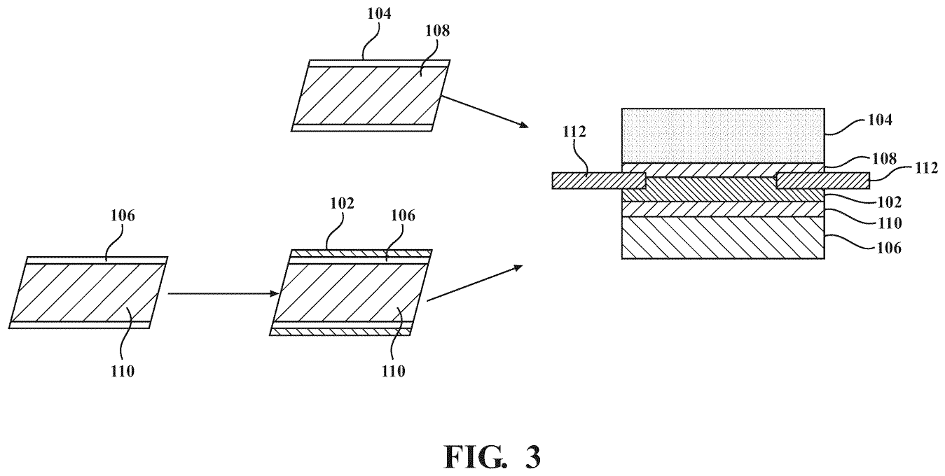

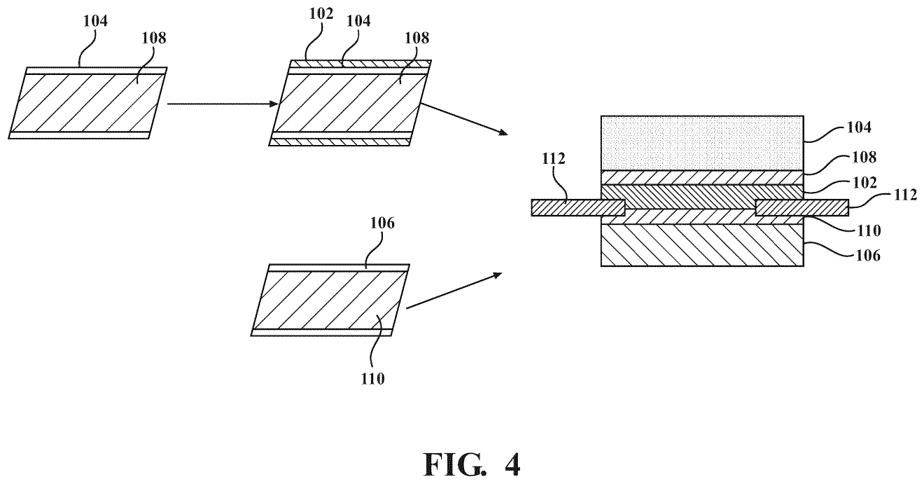

In some implementations, the membrane 102 may be applied directly to the cathode catalyst layer 110 that is on the porous substrate 106 (as shown in FIG. 3) or directly to the anode catalyst layer 108 that is on the corrosion resistant substrate 104 (as shown in FIG. 4) to form a gas diffusion electrode membrane assembly (GDEMA). In other implementations, the membrane 106 may be applied directly to the substrates 104, 106 simultaneously with the catalyst layers 108, 110. The membrane 102 may be applied by wet coating, spraying, sputtering and/or other suitable methods. The membrane 102 may be applied as a single layer or as multiple layers. The membrane 102 may be applied in a single step or multiple steps. The membrane 102 can include reinforcement, gas recombination, chemical mitigation, and other additive materials. After application of the membrane material to one of the electrode layers, the GDEMA may be dried using heat treatment, plasma treatment, or any other suitable process.

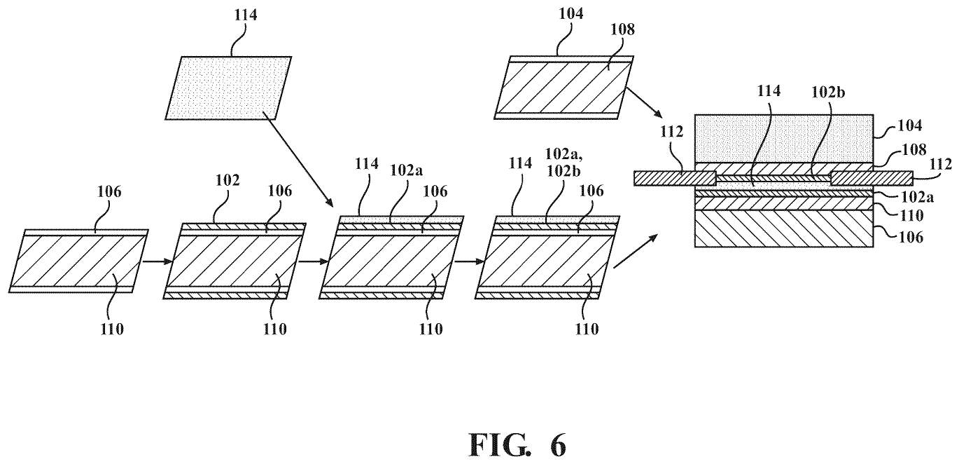

Referring to FIG. 3, the MEA 100 may be manufactured via lamination. Specifically, the corrosion resistant substrate 104 is coated with the anode catalyst ink to form the anode catalyst layer 108, and the porous substrate 106 is coated with the cathode catalyst ink to form the cathode catalyst layer 110. In some implementations, the membrane 102 is simultaneously applied to the porous substrate 106 with the cathode catalyst layer 110 in a single process step, e.g., using a dual-slot slot die coater or other multilayer coating process. In other implementations, the membrane 102 is subsequently applied to the porous substrate 106 coated with the cathode catalyst layer 110. Then, the corrosion resistant substrate 104 coated with the anode catalyst layer 108 and the porous substrate 106 coated with the cathode catalyst layer 110 are laminated with the membrane 102 and held in place by a gasket 112. In some implementations, the gasket 112 may be between the membrane 102 and the anode catalyst layer 108 (as shown in FIG. 3) or the gasket 112 may be between the membrane 102 and the cathode catalyst layer 110. The manufacturing may be performed at a single location or facility. In some implementations, as shown in FIG. 6, reinforcement materials 114 may be applied to the membrane 102.

Referring to FIG. 4, the MEA 100 may be manufactured via lamination. Specifically, the corrosion resistant substrate 104 is coated with the anode catalyst ink to form the anode catalyst layer 108, and the porous substrate 106 is coated with the cathode catalyst ink to form the cathode catalyst layer 110. In some implementations, the membrane 102 is simultaneously applied to the corrosion resistant substrate 104 with the anode catalyst layer 108 in a single process step, e.g., using a dual-slot slot die coater or other multilayer coating process. In other implementations, the membrane 102 is subsequently applied to the corrosion resistant substrate 104 coated with the anode catalyst layer 108. Then, the corrosion resistant substrate 104 coated with the anode catalyst layer 108 and the porous substrate 106 coated with the cathode catalyst layer 110 are laminated with the membrane 102 and held in place by a gasket 112. In some implementations, the gasket 112 may be between the membrane 102 and the anode catalyst layer 108 or the gasket 112 may be between the membrane 102 and the cathode catalyst layer 110 (as shown in FIG. 4). The manufacturing may be performed at a single location or facility.

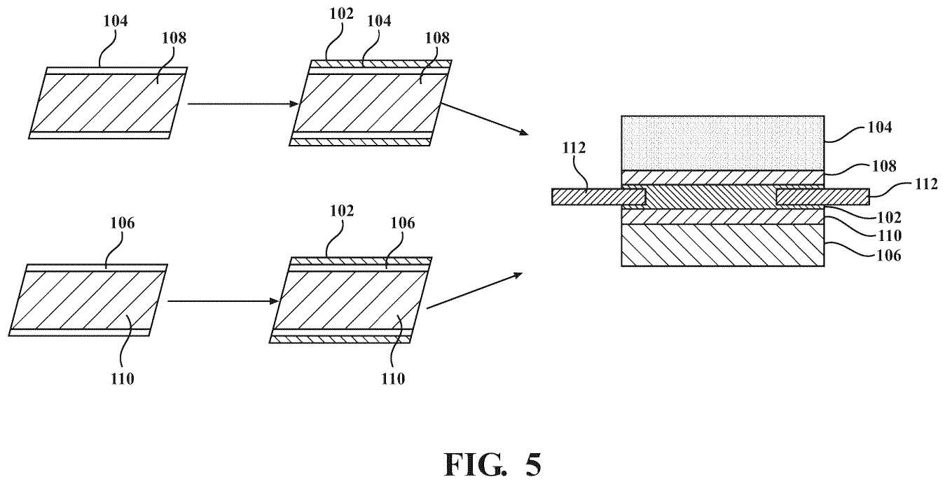

Referring to FIG. 5, the MEA 100 may be manufactured via lamination. Specifically, the corrosion resistant substrate 104 is coated with the anode catalyst ink to form the anode catalyst layer 108, and the porous substrate 106 is coated with the cathode catalyst ink to form the cathode catalyst layer 110. In some implementations, the membrane 102 is simultaneously applied to the porous substrate 106 with the cathode catalyst layer 110 in a single process step, e.g., using a dual-slot slot die coater or other multilayer coating process. In other implementations, the membrane 102 is subsequently applied to the porous substrate 106 coated with the cathode catalyst layer 110. In some implementations, the membrane 102 is simultaneously applied to the corrosion resistant substrate 104 with the anode catalyst layer 108 in a single process step, e.g., using a dual-slot slot die coater or other multilayer coating process. In other implementations, the membrane 102 is subsequently applied to the corrosion resistant substrate 104 coated with the anode catalyst layer 108. Then, the corrosion resistant substrate 104 coated with the anode catalyst layer 108 and the porous substrate 106 coated with the cathode catalyst layer 110 are laminated with the membrane 102 and held in place by a gasket 112. In some implementations, the gasket 112 may be between the membrane 102 applied to the anode catalyst layer 108 and the membrane 102 applied to the cathode catalyst layer 110 (as shown in FIG. 5). The manufacturing may be performed at a single location or facility.

Referring to FIG. 6, the MEA 100 may be manufactured in a manner similar to that described with respect to FIG. 3. Additionally, as shown in FIG. 6, reinforcement materials 114 may be applied to the membrane 102. After application of the reinforcement materials 114 to the membrane 102, the GDEMA may be dried using heat treatment, plasma treatment, or any other suitable process. In this configuration, a first portion of the membrane 102a is simultaneously applied to the porous substrate 106 with the cathode catalyst layer 110 or subsequently applied to the porous substrate 106 coated with the cathode catalyst layer 110. After the reinforcement materials 114 are applied to the GDEMA, a second portion of the membrane 102b is simultaneously applied to the porous substrate 106 with the cathode catalyst layer 110 or subsequently applied to the porous substrate 106 coated with the cathode catalyst layer 110. In some implementations, after the reinforcement materials 114 are applied to the GDEMA, a second portion of the membrane 102b is applied directly to the reinforcement materials 114, and the GDEMA is subsequently dried using heat treatment, plasma treatment, or any other suitable process. Then, the corrosion resistant substrate 104 coated with the anode catalyst layer 108 and the porous substrate 106 coated with the cathode catalyst layer 110 are laminated with the membrane 102 and held in place by a gasket 112. In some implementations, the gasket 112 may be between the first portion of the membrane 102a and the second portion of the membrane 102b (as shown in FIG. 6), between the second membrane layer 102b and anode electrode layer 108, or between the first membrane layer 102a and the cathode electrode layer 110.

The systems and methods described herein improve the interface connection between the catalyst layers 108, 110 and the membrane 102, permit more flexibility on material design and selection for the membrane 102, and allows for rapid tuning and adjustment of characteristics on-site during manufacture of the MEA 100 rather than obtaining the MEA 100 from another source. The systems and methods described herein also reduce costs compared to conventional processes which require an addition lamination process step as well as use of a sacrificial polymer film on which the membrane is coated prior to lamination.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A gas diffusion electrode membrane assembly for one of a proton exchange membrane electrolyzer or an alkaline exchange membrane electrolyzer to generate hydrogen for use as fuel in a vehicle, the electrode membrane assembly comprising:
a substrate including an electrode layer applied directly to the substrate, the substrate being formed of one or more gas diffusion layers including a macro porous substrate and microporous layers, the electrode layer including an electrocatalyst; and
a membrane applied directly to the electrode layer that is on the substrate, the membrane being applied directly to the electrode layer that is on the substrate using at least one operation including wet coating, spraying, or sputtering;
wherein applying the membrane directly to the electrode layer that is on the substrate is performed at a single location as part of a single process.

2. The gas diffusion electrode membrane assembly of claim 1, further comprising a second substrate including a second electrode layer and a second membrane that is applied to the second electrode layer.

3. The gas diffusion electrode membrane assembly of claim 2, further comprising a reinforcement layer applied to one of the membrane and the second membrane, wherein the reinforcement layer is laminated between the membrane and the second membrane.

4. The gas diffusion electrode membrane assembly of claim 1, further comprising an electrolyte that is an anion exchange ionomer.

5. The gas diffusion electrode membrane assembly of claim 1, wherein the membrane includes a perfluorosulfonic acid ionomer.

6. The gas diffusion electrode membrane assembly of claim 1, wherein the electrocatalyst includes a precious metal selected from the group consisting of platinum, iridium, ruthenium, and ruthenium-iridium.

7. The gas diffusion electrode membrane assembly of claim 1, wherein the membrane includes chemical mitigation additives including one or more of Cerium, Manganese, Cobalt, salts, or oxides.

8. A gas diffusion electrode membrane assembly for one of a proton exchange membrane electrolyzer or an alkaline electrolyzer, the electrode membrane assembly comprising:
a substrate formed of one or more gas diffusion layers including a macro porous substrate and microporous layers, the electrode layer including a platinum-based metal alloy;
an electrode layer including a platinum-based metal alloy; and
a membrane integrated with the electrode layer and simultaneously applied to the substrate with the electrode layer;
wherein applying the membrane and the electrode layer directly to the substrate is performed at a single location as part of a single process.

9. The gas diffusion electrode membrane assembly of claim 8, further comprising a second substrate including a second electrode layer and a second membrane that is applied to the second electrode layer.

10. The gas diffusion electrode membrane assembly of claim 9, further comprising a reinforcement layer applied to one of the membrane and the second membrane, wherein the reinforcement layer is laminated between the membrane and the second membrane.

11. The gas diffusion electrode membrane assembly of claim 8, further comprising an electrolyte that is an anion exchange ionomer.

12. The gas diffusion electrode membrane assembly of claim 8, wherein the membrane includes a perfluorosulfonic acid ionomer.

13. The gas diffusion electrode membrane assembly of claim 8, wherein the electrocatalyst includes a precious metal selected from the group consisting of platinum, iridium, ruthenium, and ruthenium-iridium.

14. The gas diffusion electrode membrane assembly of claim 8, wherein the membrane includes chemical mitigation additives including one or more of Cerium, Manganese, Cobalt, salts, or oxides.

15. A method for making a gas diffusion electrode membrane comprising:
providing a substrate;
performing one of:
applying an electrode layer directly to the substrate and applying a membrane directly to the electrode layer; or
integrating an electrode layer with a membrane and simultaneously applying the electrode layer and the membrane to the substrate.

16. The method of claim 15, wherein the membrane may be applied directly to the electrode layer or the substrate as a single layer or as multiple layers.

17. The method of claim 15, further comprising the step of providing an electrolyte that is an anion exchange ionomer.

18. The method of claim 15, wherein the membrane includes a perfluorosulfonic acid ionomer.

19. The method of claim 15, wherein the electrocatalyst includes a precious metal selected from the group consisting of platinum, iridium, ruthenium, and ruthenium-iridium.

20. The method of claim 15, wherein the membrane includes chemical mitigation additives including one or more of Cerium, Manganese, Cobalt, salts, or oxides.
